(19) United States
(12) Patent Application Publication
(10) Pub. No.: US 2002/0096509 A1
(43) Pub. Date: Jul. 25, 2002

(54) Catering trolley

(75) Inventor: Horst Mosshammer Von Mosshaim, Lewis Center, OH (US)

Correspondence Address: LOUIS F WAGNER, BUCKINGHAM DOOLITTLE & BURROUGHS, LLP, 50 S MAIN STREET, P O BOX 1500, AKRON, OH, 44309-1500, US

(73) Assignee: Mosshaim Innovations, Inc., Columbus, OH

(21) Appl. No.: 09/683,251

(22) Filed: Dec. 5, 2001

Related U.S. Application Data
(60) Provisional application No. 60/314,414, filed on Aug. 23, 2001.

(30) Foreign Application Priority Data
Dec. 6, 2000 (ZA) 20007202

(51) Int. Cl. H05B 3/68

(52) U.S. Cl. 219/452.11; 219/450.1; 219/391

(57) ABSTRACT

The invention relates to a portable battery-powered cooking device using improved heating units, with recharging capabilities, optionally with refrigeration capabilities.

### BACKGROUND OF INVENTION

The invention described herein pertains generally to a catering trolley designed to permit heating and/or cooking, optionally with refrigeration, of food away from a kitchen.

The applicant is aware that presently catering trolleys for use in restaurants and function venues use gas as a source of heat. Thus, present catering trolleys have one or two gas burners mounted onto a trolley with a gas cylinder being located somewhere on the trolley to provide gas to the burners.

One drawback of such a system is that the gas bottle is heavy and also there are the inherent dangers of working with gas in enclosed areas, such as small dining halls and the like.

### SUMMARY OF INVENTION

Thus, according to a first aspect of the invention, there is provided an improved catering trolley having one or more self-contained sources of electrical power supply.

It is an object of this invention to provide a catering trolley that includes one or more cooker plates powered by a battery-operated electrical power supply.

It is another object of this invention to provide a catering trolley that includes a refrigerated drawer or other cooking unit wherein the refrigerated drawer may be powered by the electrical power supply or wall circuit alternating current depending on the mode of operation.

It is yet another object of this invention to provide one or more self contained sources of electrical power supply that include one or more batteries sized for supplying the electrical power, optionally including a fuel cell electricity generation system.

It is still yet an object of this invention to provide the electrical power supply in the form of one or more batteries, conventional, e.g., lead acid batteries, or novel batteries, e.g., NiMH (nickel metal hydride) rechargeable batteries, or any other type rechargeable battery.

These and other objects of this invention will be evident when viewed in light of the drawings, detailed description, and appended claims.

### BRIEF DESCRIPTION OF DRAWINGS

The invention may take physical form in certain parts and arrangements of parts, a preferred embodiment of which will be described in detail in the specification and illustrated in the accompanying drawings which form a part hereof, and wherein:

FIG. 1 is an isometric projection of a set of two hot plate modules, assembled in a linear array;

FIG. 2 is an isometric projection of a corner hot plate module, suitable as part of a set including a chamfered corner;

FIG. 3 is an isometric projection of three hot plate modules of a set arranged in an L-shaped configuration;

FIG. 4 is a perspective elevation of three hot plate modules of a set arranged in rectilinear succession;

FIG. 5 represents a plan view of a locating clip for holding together adjoining modules of a set;

FIG. 6 is a top plan view of a Prior Art single hot plate with spiral radiant heating element with vitreous ceramic top shown in ghost lines;

FIG. 7 is a top plan view of a single hot plate of the invention with inner housing within an outer housing with ribbon heating element and vitreous ceramic top shown in ghost lines;

FIG. 8 is a spaced apart schematic view of a single insulated heating element with sensor positioned above the spiral radiant heating element;

FIG. 9 is a spaced apart schematic view of a single hot plate unit with spiral radiant heating element positioned within the windowed inner housing which is positioned within the outer housing;

FIG. 10 is a perspective view of an assembled single hot plate unit with vitreous ceramic top partially shown;

FIG. 11 is an isometric view of a bottom portion of a beveled embodiment of the insulation;

FIG. 12 is an enlarged cross-sectional view of FIG. 11 taken along line 12-12;

FIG. 13 is a top plan view of a catering trolley of the present invention using heating elements as described in FIGS. 1-12;

FIG. 14 is a side plan view of the catering trolley of FIG. 13;

FIG. 15 is an end view of the catering trolley of FIGS. 13-14;

FIG. 16 is a wiring diagram for an inverter and charger for use with the trolley and heating elements shown in FIGS. 1-15.

### DETAILED DESCRIPTION

Referring now to the drawings wherein the showings are for purposes of illustrating the preferred embodiment of the invention only and not for purposes of limiting the same, the Figures show modular hot plates that can be combined in various ways as used generally in a catering trolley 400 in accordance with the invention.

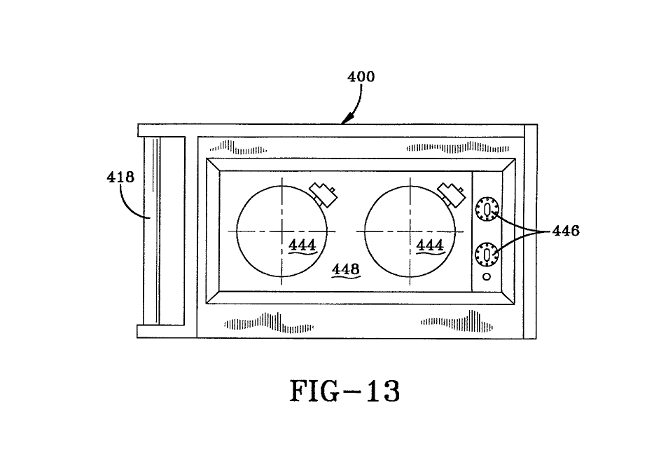

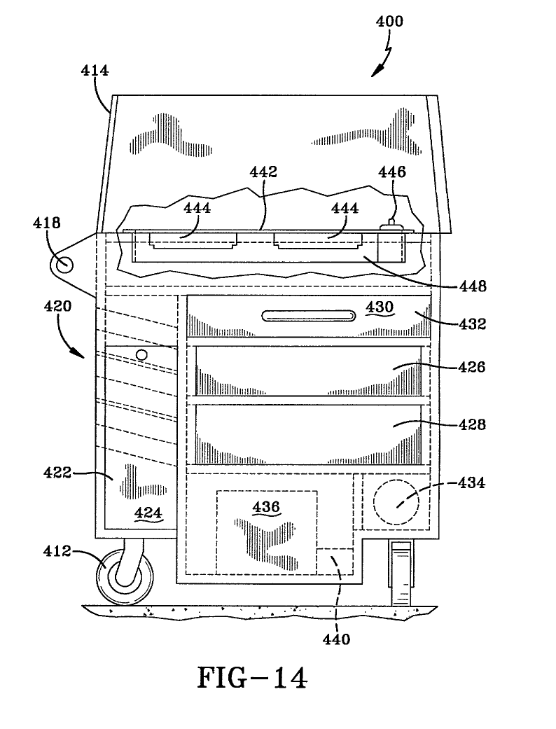

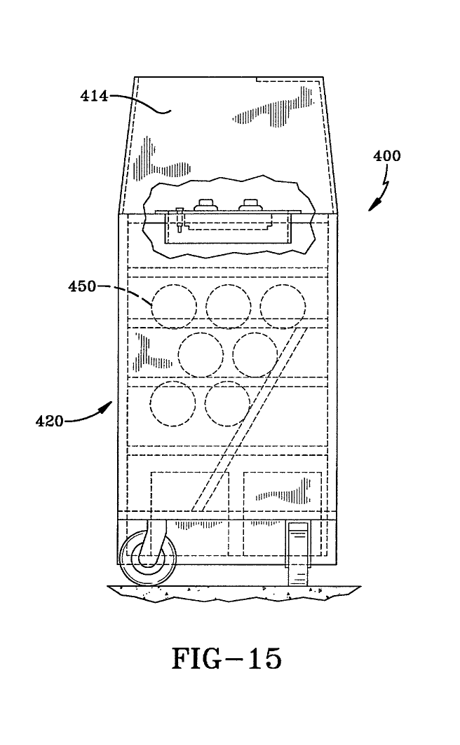

As illustrated in FIGS. 13-15, the trolley 400 is made of stainless steel with the exception of the wheels 412 which have rubber running surfaces. The trolley has a sneeze guard 414, a flip down cutting board 416, and a handle 418.

The body 420 of the trolley 400 has a vertically positioned trash compartment 422 at the rear of the trolley 424. The trolley has horizontally extending cavities 426, and 430, of which cavity 430 has a drawer 432 for storing knives, plates and any other items. The other cavities 426 and 428 are used as pan storage areas. A storage area 434 for storing safety equipment, such as a fire extinguisher, is provided, as is a bottle storage area 450 at the rear of the trolley.

In another embodiment, not shown, a small refrigerated drawer is provided on the trolley 400 for storing beverages, ingredients and the like. The refrigerated drawer also be powered from the inverter 440.

The trolley is provided with a battery compartment 436 in which at least two 12 V (volt) NiMH car batteries can be stored for providing a direct current (DC) power supply to the inverter 440 which converts the DC power to alternating current (AC) power. The inverter 440 provides a 120 V AC supply for powering the cooker unit 448. The applicant believes that it is an advantage of the invention as illustrated that an electrically powered catering trolley having a self-contained electricity supply source is provided which does not suffer from the dangers and inconveniences of a gas catering trolley. The vehicle type batteries may provide any output voltage, however, typically said batteries will together provide 36 V DC which can be converted to 120 V AC for use in powering the cooker plate and/or the refrigerated drawer. The individual batteries making up the source of the electrical power supply are typically 12 V batteries in any suitable configuration. The catering trolley may be configured such that the self contained source of electrical power is sized to power the cooker plates and/or the refrigerated drawer for at least 2 hours, preferably at least 2.5 hours. The catering trolley will include a charger for charging the batteries from a main electricity supply socket, such as a 15 Amp socket available in most residential and commercial properties.

The inverter may be a Cherokee™ TS-250 inverter unit which is configured to provide a 120 V AC output from a 36 V DC input. The inverter 440 provides 2400 W continuous output power as well as 4000 W peak power for 20 seconds, or longer. The inverter 440, running off 3 NiMH car batteries (not shown) is configured to power the cooker plates for at least 90 minutes before the batteries require recharging. the inverter is preferably configured to convert 36 V DC to 120 V AC, the inverter may be selected to convert any available DC voltage to a usable AC voltage. It is possible for a number of inverters may be used together to provide higher power output, if required.

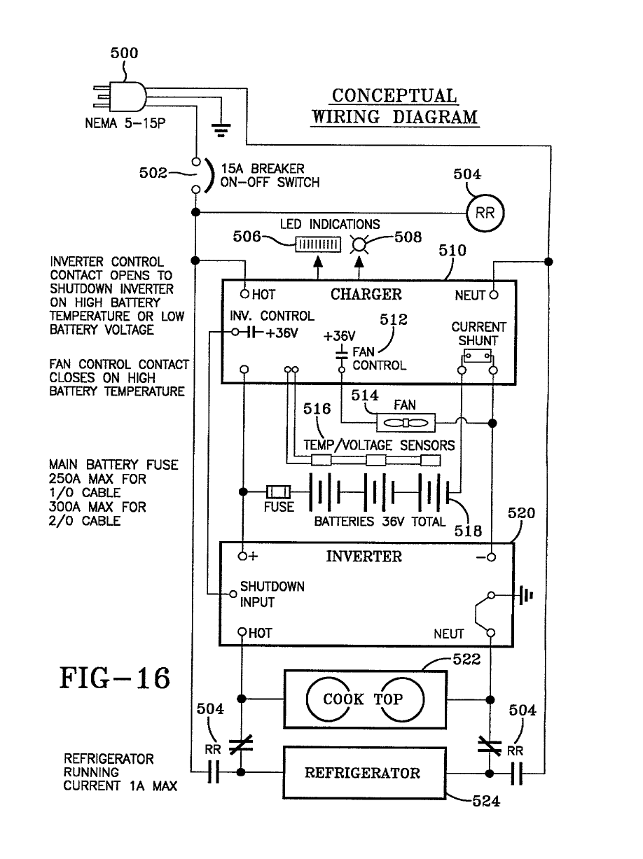

As illustrated in FIG. 16, a wiring schematic is shown which interfaces recharging capabilities to the batteries used to power both the cook top and refrigerated drawer. Whenever AC power cord 500 is plugged into a wall outlet, it transfer the refrigerated drawer 524 from battery 518/inverter 520 power to power derived from the wall socket. This is desirable during battery charging periods because the refrigerated drawer would take some of the recharging current and lengthen the charge time. Additionally, if the cart is used for an event that requires cooking for longer periods of time than the battery capacity alone can support, the operator has the option of plugging the cord into any 15 amp wall outlet to supplement battery power. In this mode, the charger will offset some of the current being drawn from the batteries while using the burners. During any brief period when the burners are not used, the charger will partially recharge the batteries. Again, in this mode, the refrigerator will be powered from wall power through the RR relay 504, further saving battery capacity. As illustrated in the Figure, the schematic includes a 15 amp circuit breaker on/off switch 502 in combination with a charger 510, an inverter 520, a cooking surface 522 and a refrigerated drawer 524. When in the charging mode, the charger has visual indications of charging mode operation via a lighted display (LED) 508 as well as charging progress display 506. The charging unit additionally contains temperature/voltage sensors 516 in electrical communication with fans 514 to insure that operation does not result in overheating of the power supplies whereby the control contact opens to shut down the inverter on high battery temperature or low battery voltage. The fan control contact closes on high battery temperature.

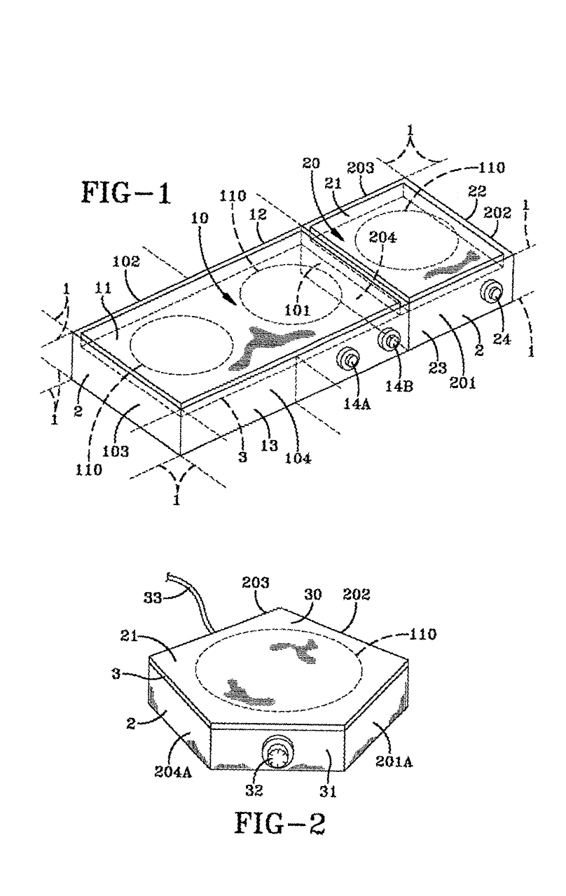

In the top of the trolley 442 is provided a two cooker plate Series S stove top cooker unit 448 having a glass top 444 and control panel 446. As more fully illustrated in FIGS. 1-12, the modular table model hot plates for cooking having substantially square or rectangular outlines in plan view, comprising the following features in combination: (a)each hot plate forms a module having one or more sides of the square or rectangular outlines exactly matching one or more sides of one or more other hot plates of the set when placed in close fitting side by side relationship;(b) each hot plate of the set having a vitreous ceramic top covering one or more radiant heating element bodies;(c)each vitreous ceramic tops of the set, when the individual modules are placed side by side with said matching sides in close fitting contact, combine to form a level top surface, interrupted by joint lines of minimal width between the vitreous ceramic tops.

The vitreous ceramic tops, which are preferably adhesively bonded in conventional manner onto a marginal shoulder or flange at the top of the base of each unit have outlines as closely as practical matching the plan view outlines of the sides of the units but not projecting these beyond in order not to interfere with the close fitting contact of the sides of adjoining units. A conventional silicone adhesive may be used for bonding the vitreous ceramic top onto the shoulder or flange.

Optionally, but not preferably, each vitreous ceramic top may be bordered by retaining ledges, one or more of which constitute the upper part of a side as defined in (a). Although these retaining ledges facilitate positioning of the vitreous ceramic tops during assembly and obviate the use of assembly jigs, they impose limitations on the extent to which the joint between adjoining vitreous ceramic tops can be minimized due to the minimum thickness of the material (usually sheet metal) of the ledges.

These ledges, if present, may be as narrow as about 0.5-2.5, more preferably 0.70 to 2.3 mm, say 1 mm. More preferably the ledges are omitted entirely, permitting the vitreous ceramic tops to adjoin as closely as manufacturing tolerances allow.

Preferably the side lengths of the modules are equal to form one or more square modules, or when different, the longer side lengths are whole number multiples of the shorter side lengths. These side lengths are preferably selected so that they or multiples thereof substantially correspond to standard side lengths of table and appliance tops, in particular standard table tops in modular kitchen furniture.

Preferably one side, usually the front of each module is designed as a control panel carrying operating and/or control buttons, touch pads, knobs, and/or dials and optionally one or more pilot lights.

A particular embodiment of such set includes a corner module having essentially square or rectangular outlines as aforesaid, but modified in that one corner is chamfered to form a fifth side, which is preferably considerably shorter than any of the remaining sides, being designed as a control panel carrying operating and/or control buttons, touch pads, knobs or dials and optionally one or more pilot lights.

In use such a set may comprise a plurality of modules arrayed in an L-shaped configuration with a corner module as aforesaid forming the corner of the L.

Alternatively, at least one said corner module is set up for the chamfered corner to be at an end of a rectilinear succession of modules. Advantageously, the set includes locating and position retaining mean for retaining the modules in their relative positions having been placed in a selected array. For example, the locating and position retaining means are devices adapted to engage with support buttons or feet of adjoining modules. Alternatively, the locating and position retaining means are catches or clips for locking together the adjoining sides of adjoining modules.

The scope of the invention extends to the individual modules of the set adapted to be used in combination as described above, more particularly by incorporating some or all of the features as set out above.

The individual modules may be supplied with plans and/or instructions, e.g., in or on a package, e.g., a carton containing one or more modules explaining layouts for combining modules in advantageous arrays.

The invention further includes in its scope, a pentagonal table model hot plate, usable as a corner module in a set as disclosed above having square or rectangular outlines as aforesaid, one corner of which is chamfered to form a fifth side, this fifth side being designed as a control panel carrying operating and/or control buttons, touch pads, knobs or dials and optionally one or more pilot lights. Besides the visual attractiveness of this design the construction offers the advantage that, when placed on a rectangular or square table or like support, the operating and control means are protected by being recessed in relation to the corner of the support.

In FIG. 1, there is shown two hot plate modules 10 and 20 combined in a linear array. Hot plate module 10 has rectangular outlines in plan view and hot plate module 20 has square outlines in plan view. Each square hot plate module 20 has four sides of equal length 201, 202, 203, and 204. Each rectangular hot plate module 10 has two opposite short sides 101 and 103 exactly matching in length a side of the square module 20 and two equal opposite long sides 102, 104 the length of which is a multiple, in this example twice the length of the short sides 101, 103.

The hot plates include a base 2, having said rectangular outlines and a vitreous ceramic top 11, 17 covering one or more radiant heating element bodies 110. Each vitreous ceramic top 11, 21 may be bordered by retaining ledges 12, 22 the thickness of which have been greatly exaggerated in the drawing, being in practice only about 1 mm thick, and which if present, constitute the upper part of the sides of the hot plate module. Alternatively and preferably the retaining ledges are omitted entirely.

The vitreous ceramic tops are each bonded with silicone or equivalent adhesive onto a shoulder or marginal flange at 3.

The broken lines 1 indicate that further modules can be added on in a variety of manners to extend the array of modules as needed and to match an available kitchen furniture top area or other working top area. It is clear that the set of modules offers a great many options to meet customer requirements at any given time, while permitting the removal of individual modules for temporary use elsewhere, e.g., in a different room or even outdoors.

The hot plate modules are placed side by side with the matching sides in close fitting contact so that the vitreous ceramic tops 11, 21 of the hot plates combine to form a top level surface, interrupted only by the joint lines formed by the retaining ledges 12 and 22.

The longer side lengths of the hot plate module 10 as shown are twice the length of the shorter side lengths. However, it will be understood that modules may be provided having longer side lengths three or more times the shorter side length.

The front side of the modules 13, 23 are designed as control panels carrying control dials 14A, 14 Band 24 and optionally pilot lights. The control dials switch on and off and control the temperature of the ribbon or radiant heating element bodies 110.

The direction in which the control panels of the individual modules are made to face in a given array is optional.

In FIG. 2 there is shown a corner hot plate modules having essentially the same square outlines as module 20 in FIG. 1 but modified in that one corner is chamfered to form a fifth side 31 connecting the shortened sides 201a and 204a. The fifth side 31 is considerably shorter than any of the remaining sides and is designed as a control panel and carries a control dial 32 for switching on and off and controlling the temperature of the radiant heating element bodies 110. The module includes a power supply cord 33.

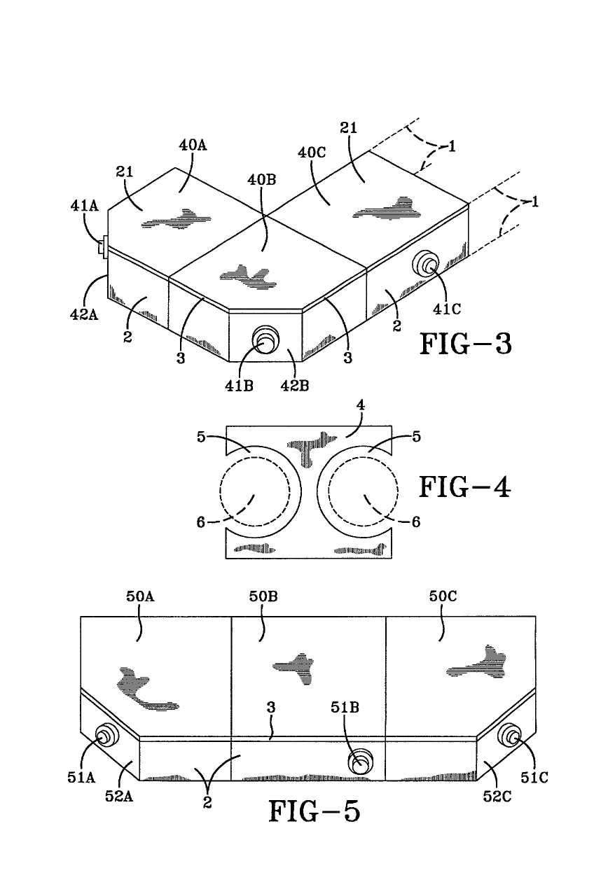

FIG. 3 illustrates three hot plate modules 40A, 40B and 40C (the later identical to square module 20 in FIG. 1) arranged in an L-shaped configuration with a corner module 40B as shown in FIG. 2 having a chamfered corner to form a fifth side 42B forming the corner of the L. In addition, a second corner module 40A is set up for fifth side 42A resulting from the chamfered corner to be at an end of the L-shape. As in FIG. 1, broken lines 1 diagrammatically indicate an optional extension of the array with one or more further modules.

Each module includes a control panel (the fifth side of the corner modules) which carries a control dial 41A, 41B and 47C for controlling the temperature of the ribbon or radiant heating element bodies (not shown).

FIG. 4 illustrates three modules 50A, 50B and 50C arranged in rectilinear succession. Two corner modules 50A and 50C as shown in FIG. 2 are set up for the fifth sides 52A and 52C resulting from the chamfered corners to be at either end of the succession of modules. The intermediate module SOB is a square module like module 20 in FIG. 1 or could be a rectangular module like module 10 in FIG. 1. Each module carries a control dial 51A, 51B and 51C on the front control panel (the fifth side in the corner modules). The control dial is for controlling the temperature of the radiant element heating bodies (not shown).

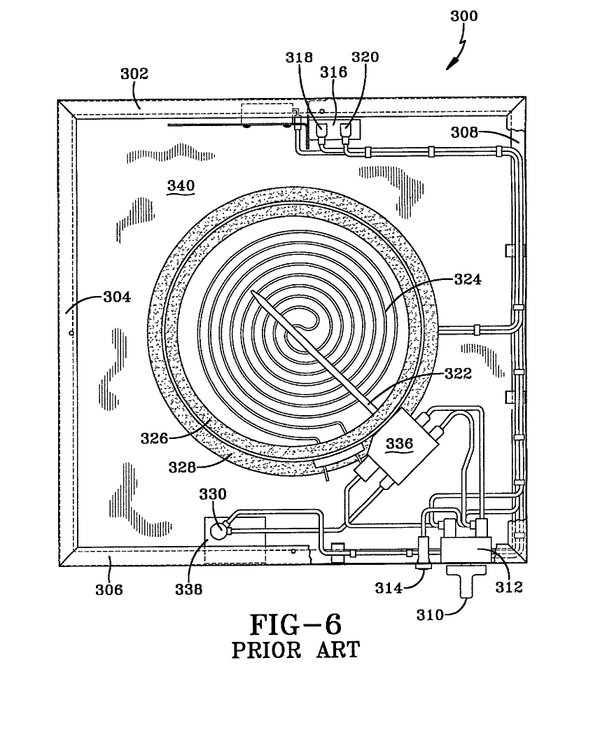

Referring now to FIG. 5, a resilient clip 4 of rubber is shown having open-ended rebates 5 for accommodating rubber feet 6 on the underside of the corner regions of adjoining modules (not shown). These clips represent one of a variety of possibilities for optionally stabilizing the relative positions of adjoining modules in a given array.

FIG. 6 illustrates a top plan view of a Prior Art single hot plate 300 with vitreous ceramic top 340 shown outlined in ghost lines. The hot plate has an outer housing with four connected walls, 302, 304, 306, 308 shown in a square configuration, although rectangular and chamfered arrangements as described above are within the scope of this invention. Raceways are optionally positioned within the walls for containment of electrical wiring harnesses. Electrical communication with household current is effected through alternating current (AC) inlet 316 having a neutral 318, hot 320 and typically neutral (not shown) wire. Heating is effected via ribbon or spiral heating element 324 with continuously variable control 310 using rheostat 312.

Visual indication of heating is observed via pilot light 314. Temperature control is maintained via feedback circuitry 336 predicated on readings from temperature sensor 322. Lateral heat migration is minimized through circular insulating rings 326, 328 positioned about heating element 324. Residual hot surface protection is effected via residual heat indicator light 330 positioned within residual heat indicator light bracket 338.

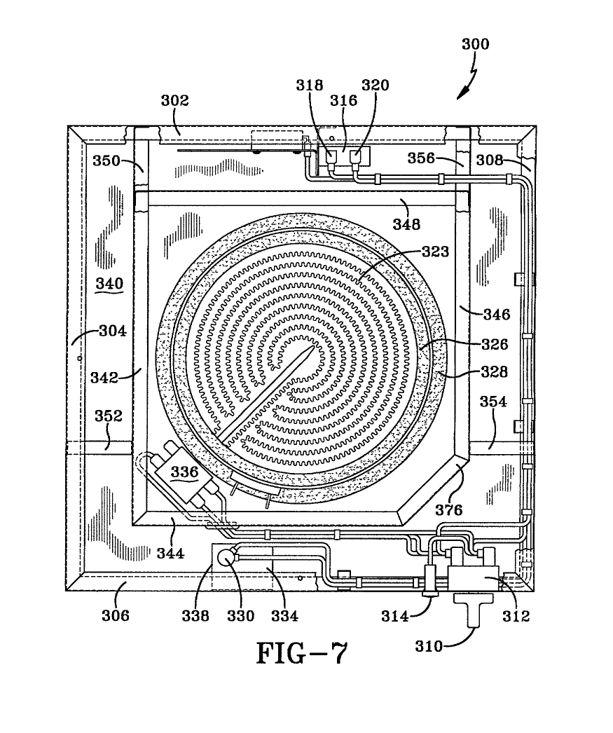

As best illustrated in FIG. 7, the invention which more effectively minimizes lateral heat migration, particularly when EGO HiLight ribbon heating elements 323 are used, builds on the components identified in FIG. 6 and adds an inner housing comprising four connected walls 324, 344, 346, 348 of dimensions smaller than those of outer housing connected walls 302, 304, 306 and 308. It should be noted that the reduction in size of the inner walls need not be in the same ratio for all walls, and that chamfered walls 316 are also envisioned within the scope of this invention.

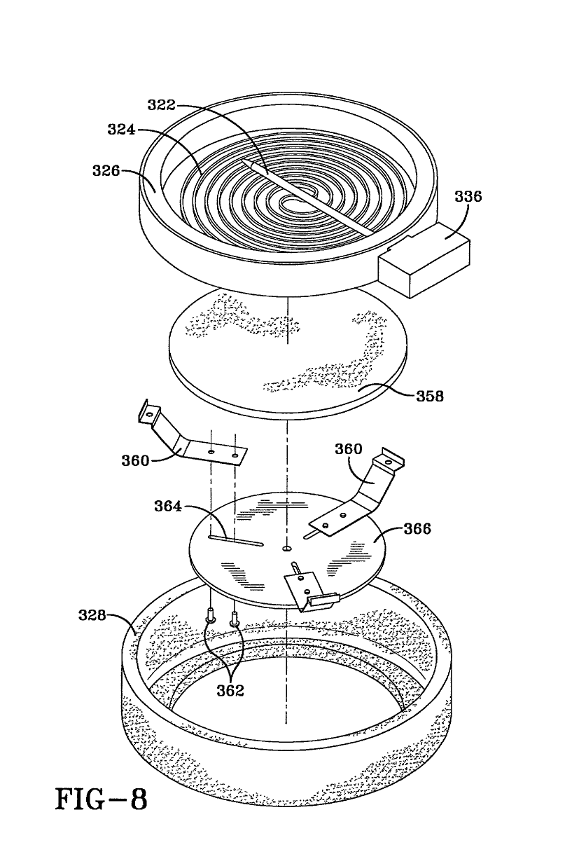

As better illustrated in FIG. 8, which is a spaced apart schematic view of a single insulated heating element with sensor positioned above the heating element, the heating elements 324 of the hot plate unit are surrounded by two circular insulating rings, an inner insulating ring 326 and an outer insulating ring 328 with a bottom inwardly facing shelf dimensioned so as to accommodate an insulating circular plate 358. Secure positioning of the insulating materials about the hot plate heating element are effected via a retaining means, e.g., a plate 366 with a plurality of slots 364 to permit sliding positioning of brackets 360 via fastening means e.g., nuts and bolts or rivets 362.

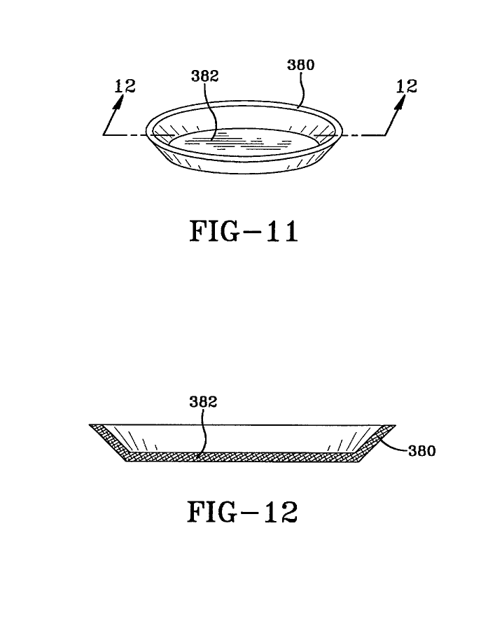

While a flat insulating plate 358 is illustrated in FIG. 8, a beveled embodiment is illustrated in FIG. 11, an isometric view of a beveled bottom insulating component, also shown in cross-section in FIG. 12, a cross-section of FIG. 11 taken along line 12-12. In this embodiment, the bottom plate portion 382 has raised beveled sides 380, angled at an angle which can range from 5 to 85°, preferably from 25-65°, more preferably about 45°.

In a preferred embodiment, the insulating means will be SUPERWOOL® 607® board, a rigid self-supporting synthetic vitreous fiber insulation commercially available in a variety of sizes and thicknesses from Vacuform, Sebring, Ohio. This soluble amorphous wool product material has a 1000° C. maximum temperature rating. Superwool 607 board is processed from a slurry consisting of Superwool 607 bulk, fillers, and binders. The Superwool 607 bulk raw material is made from a calcium magnesium silicate composition. Chemically, the material contains approximately the following percentages in a preferred embodiment:

Chemical Analysis (% weight basis after firing)

| Component | Chemical Formula | Percentage |
|---|---|---|
| Alumina | Al₂O₃ | — |
| Silica | SiO₂ | 67 |
| Calcium oxide | CaO | 27 |
| Magnesium oxide | MgO | 5 |
| Other | | 1 |
| Loss on Ignition | L.O.I. | 4-7 |

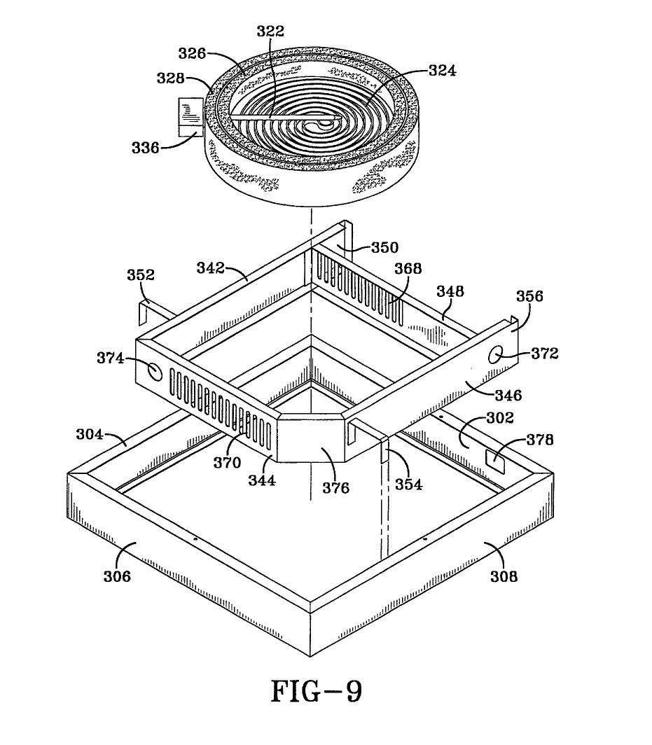

FIG. 9 illustrates a spaced apart schematic view of a single hot plate unit positioned within the windowed inner housing which is positioned within the outer housing. The inner housing is fastened within the outer housing by protruding inner leg extensions 350, 356 or can be effected via clip arrangements 352, 354 or which can be spot welded to the outer housing. Apertures 372, 374 permit electrical wiring harnesses to penetrate between the inner and outer housings while aperture 378 permits electrical communication within attached units. A rubber grommet is typically positioned within each aperture. A plurality of windowed apertures or slits 368, 370 allow any excess accumulated heat to be dissipated from within the inner housing to the interior of the outer housing for ultimate dissipation through egress openings in the bottom floor of the hot plate unit (not shown). While windowed apertures 368, 370 are shown only within inner housing walls 348, 344 respectively, there is no need to limit the invention to such and in fact, all walls may contain these vents or no walls may contain the vents, depending on the design specifications required.

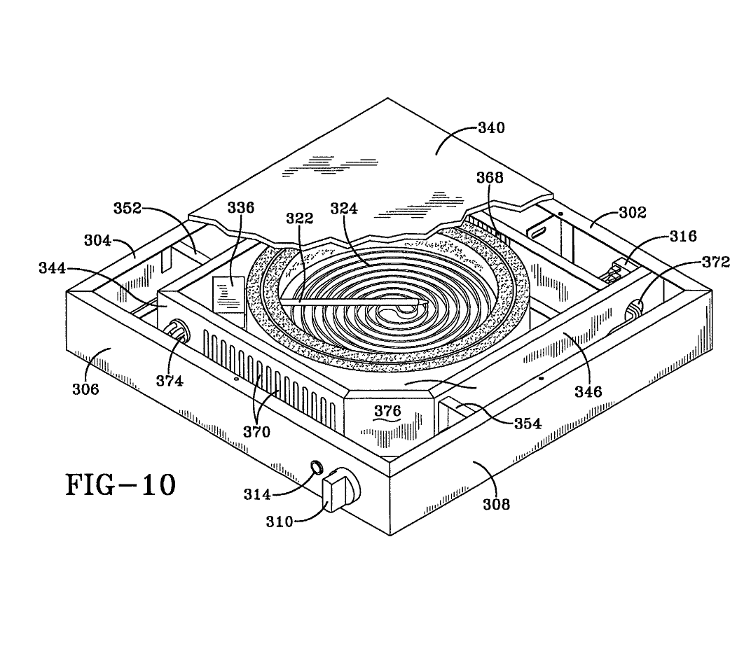

As shown in FIG. 10, a perspective view of an assembled single hot plate unit with vitreous ceramic top partially shown, the combination of inner insulating ring 326 coupled with outer insulating ring 328 in combination with insulating circular plate 358, the heat generated by heating elements 324 are directed toward vitreous ceramic surface 340 with minimal lateral and downward heat migration. This permits a hot cooking surface where the cooking pot or pan is positioned while the remainder of the ceramic top and outer housing sides remain significantly cooler, thereby permitting a user to move or reposition the heating units without having to wait for them to cool to the touch.

The best mode for carrying out the invention has been described for the purposes of illustrating the best mode known to the applicant at the time. The examples are illustrative only and not meant to limit the invention, as measured by the scope and spirit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof.

1. A catering trolley which comprises:
(a)a moveable frame;
(b)at least one electrical heating element in said frame;
(c)a rechargeable electrical direct current power source;
(d)an electrical power converter in electrical communication with said rechargeable electrical direct current power source to transform said direct current into alternating current for use by said electrical heating element.

2. The trolley of claim 2 which further comprises
(a)a refrigerated component within said trolley in electrical communication with said electrical power converter.

3. The trolley of claim 1 wherein
(a)said rechargeable electrical direct current power source is at least two twelve volt rechargeable batteries.

4. The trolley of claim 3 wherein
(a)said rechargeable electrical direct current power source is at least three twelve volt rechargeable batteries.

5. The trolley of claim 3 wherein
(a)said electrical power converter is an inverter unit.

6. The trolley of claim 1 wherein
(a)said at least one electrical heating element comprises
(i)a hot plate having a vitreous ceramic top covering one or more radiant heating element bodies; and
(ii)a control module for variable control of said one or more radiant heating element bodies.

7. The trolley of claim 6 wherein
(a)said at least one electrical heating element comprises at least two electrical heating elements; and wherein
(b)a vitreous ceramic top covering each of said one or more radiant heating element bodies is in close fitting contact, combining to form a level top surface interrupted only by joint lines of minimal width between said vitreous ceramic tops.

8. The trolley of claim 7 which further comprises
(a)a positionable cover over said electrical heating elements.

9. The trolley of claim 6 wherein said at least one electrical heating element is a hot plate comprising:
(a)an outer housing;
(b)at least one inner housing within said outer housing;
(c)at least one heating element within said at least one inner housing;
(d)an insulating means around at least one of said heating elements;
(e)an insulating means around at least one of said heating elements; and
(f)a ceramic top on said outer housing.

10. The trolley of claim 9 wherein said insulating means comprises:
(a)an inner insulating means; and
(b)an outer insulating means.

11. The trolley of claim 10 wherein said insulating means further comprises
(a)a bottom insulating means.

12. The trolley of claim 10 wherein
(a)said outer insulating means comprises
(i)a cylinder having an inwardly facing shelf at a bottom thereof; and
(b)said bottom insulating means is essentially plate-like.

13. The trolley of claim 12 wherein
(a)said outer insulating means comprises
(i)a cylinder; and
(b)said bottom insulating means is cup-shaped having a bottom and beveled raised sides.

14. The trolley of claim 13 wherein
(a)said bottom insulating means has a beveled side angled at an angle from approximately 5 to 85° inclusive.

15. The trolley of claim 14 wherein
(a)said angle ranges from approximately 25-65° inclusive.

16. The trolley of claim 15 wherein
(a)said angle is approximately about 45°.

17. The trolley of claim 9 wherein said hot plate further comprises
(a)at least one other hot plate which forms a portable module having one or more sides of the square or rectangular outlines essentially matching one or more sides of one or more other hot plates of the set when placed in close fitting side by side relationship.

18. The trolley of claim 17 wherein
(a)said vitreous ceramic tops of said individual hot plates are in close fitting contact to form a level top surface, interrupted only by joint lines of minimal width between the vitreous ceramic tops.

19. A catering trolley which comprises:
(a)a moveable frame;
(b)at least one electrical heating element in said frame which comprises
(i)a hot plate having a vitreous ceramic top covering one or more radiant heating element bodies, and
(ii)a control module for variable control of said one or more radiant heating element bodies;
(c)a rechargeable electrical direct current power source;
(d)an electrical power converter in electrical communication with said rechargeable electrical direct current power source to transform said direct current into alternating current for use by said electrical heating element.

20. The trolley of claim 19 which further comprises
(a)a refrigerated component within said trolley in electrical communication with said electrical power converter.

21. The trolley of claim 19 wherein
(a)said rechargeable electrical direct current power source is at least two twelve volt rechargeable batteries.

22. The trolley of claim 21 wherein
(a)said rechargeable electrical direct current power source is at least three twelve volt rechargeable batteries.

23. The trolley of claim 22 wherein
(a)said electrical power converter is an inverter unit.

24. The trolley of claim 19 wherein
(a)said at least one electrical heating element comprises at least two electrical heating elements; and wherein
(b)a vitreous ceramic top covering each of said one or more radiant heating element bodies is in close fitting contact, combining to form a level top surface interrupted only by joint lines of minimal width between said vitreous ceramic tops.

25. The trolley of claim 24 which further comprises
(a)a positionable cover over said electrical heating elements.

26. The trolley of claim 19 wherein said at least one electrical heating element is a hot plate comprising:
(a)an outer housing;
(b)at least one inner housing within said outer housing;
(c)at least one heating element within said at least one inner housing;
(d)an insulating means around at least one of said heating elements;
(e)an insulating means around at least one of said heating elements; and
(f)a ceramic top on said outer housing.

27. The trolley of claim 26 wherein said insulating means comprises:
(a)an inner insulating means; and
(b)an outer insulating means.

28. The trolley of claim 27 wherein said insulating means further comprises
(a)a bottom insulating means.

29. The trolley of claim 27 wherein
(a)said outer insulating means comprises
(i)a cylinder having an inwardly facing shelf at a bottom thereof; and
(b)said bottom insulating means is essentially plate-like.

30. The trolley of claim 29 wherein
(a)said outer insulating means comprises
(i)a cylinder; and
(b)said bottom insulating means is cup-shaped having a bottom and beveled raised sides.

31. The trolley of claim 30 wherein
(a)said bottom insulating means has a beveled side angled at an angle from approximately 5 to 85° inclusive.

32. The trolley of claim 31 wherein
(a)said angle ranges from approximately 25-65° inclusive.

33. The trolley of claim 32 wherein
(a)said angle is approximately about 45°.

34. The trolley of claim 26 wherein said hot plate further comprises
(a)at least one other hot plate which forms a portable module having one or more sides of the square or rectangular outlines essentially matching one or more sides of one or more other hot plates of the set when placed in close fitting side by side relationship.

35. The trolley of claim 34 wherein
(a)said vitreous ceramic tops of said individual hot plates are in close fitting contact to form a level top surface, interrupted only by joint lines of minimal width between the vitreous ceramic tops.
